(19) United States
(12) Patent Application Publication
(10) Pub. No.: US 2010/0049606 A1
(43) Pub. Date: Feb. 25, 2010

(54) Specific Internet user target advertising replacement method and system

(75) Inventors: Robert Eugene Trzybinski, Indianapolis, IN (US); Mike Arthur Derrenberger, Fishers, IN (US); Terry Wayne Lockridge, Indianapolis, IN (US)

Correspondence Address: Robert D. Shedd, Patent Operations;THOMSON Licensing LLC, P.O. Box 5312, Princeton, NJ, 08543-5312, US

(73) Assignee: Thomson Licensing S.A.

(21) Appl. No.: 12/589,490

(22) Filed: Oct. 23, 2009

Related U.S. Application Data
(62) Division of application No. 10/494,250, filed on May 3, 2004, now abandoned.

(51) Int. Cl. G06Q 30/00; G06F 17/30

(52) U.S. Cl. 705/14.53; 707/755; 707/783; 707/E17.005; 707/E17.033

(57) ABSTRACT

A system and apparatus for delivering ancillary information related to a resource request, such as advertisements, to a resource requester via a gateway device. The invention describes the components of the gateway device receiving a request from a resource requester (210) and the gateway device referencing the request for ancillary information (240), either internally or externally via a database. Additional elements to the invention include the gateway device receiving information representing the requested resource, from a resource provider, and ancillary information related to the resource (250), and the transmission by the gateway device of ancillary information and the resource to the resource requester (260).

### FIELD OF THE INVENTION

The present invention relates to requesting resources available from a communications network, specifically the supplementing of a requested resource with ancillary information related to the requested resource.

### BACKGROUND

Through the expansion of the Internet through the late 1990's, many resources were available at little or no cost to Internet users. As economic conditions changed and the costs for operating resources increased, more resources had to supplement their incomes with additional advertising sources. Consequently, many users on the Internet receive advertisements when accessing websites or multimedia based resources.

The source of ads may be the website or multimedia resource that a user requests through a communications network (as the Internet). This type of delivery system is known as “pushing”, where the prior preferences of a resource requester are used to determine what types of ads to send to the user, from the point of the requested resource. The preferences of the requester may be due to pre-selected user options or a monitoring program that develops a profile based on the previous websites or media resources selections made by a requester.

The source of ads may also be done at the point of the resource requester. The software running on the requester's computer (such as spyware which monitors the selections of a user) or a browser directs the type of ads to be transmitted to requester. The ad requesting software may also be used to block the ads from being sent to a user's computer. Alternatively, the requesting software may block a requester from accessing a resource.

When delivering ads to a user that are delivered from the point of the user or the content provider, an architecture has to be present at either source to accommodate the display of advertisements. Hence, additional resources have to be used at the point of either the resource or a resource requester to display advertisements.

With the interaction between ads being transmitted to the user either by mechanisms at the site of the user's computer, or the content provider supplying information to the user, there are devices that at as gateways that allow a user to access and receive a requested resource. These gateway devices may be utilized to provide services to a user that neither requires software on the user's computer, or interaction on the point of a content provider interaction to provide services and advertisements related to a requested resource to enhance a user's multimedia experience.

### SUMMARY OF THE INVENTION

A system and method for providing ancillary information related to a request for a resource delivered through a communications network. Ancillary information related to a resource, as an advertisement or service, is provided by a gateway facilitating the communication of a request between a resource requester and a resource provider, without interaction at the point of resource requester and resource provider. Gateway devices resolves the request for a resource to determine the ancillary information related to the requested resource.

### BRIEF DESCRIPTION OF THE DRAWINGS

The above and other advantages and features of the present invention will be better understood from the following detailed description of the preferred embodiments of the invention, which is provided in connection with the accompanying drawings. The various features of the drawings may not be to scale. Included in the drawing are the following figures:

FIG. 1A is a diagram of a system a communication architecture presenting an exemplary embodiment of the present invention;

FIG. 1B is a diagram of components forming the communications architecture of an exemplary embodiment of the present invention;

FIG. 2 is a flowchart of an embodiment of the present invention of delivering ancillary information related to requested resource through a gateway device;

FIG. 3A is a diagram of a displayed requested resource available from resource provider via communication network; and

FIG. 3B is a diagram of a displayed requested resource available from a communications network with ancillary information related to the requested resource with an exemplary embodiment of the present invention.

### DETAILED DESCRIPTION

Although the invention is described in terms of exemplary embodiments, it is not limited thereto. Rather, the appended claims should be construed broadly, to include other variants and embodiments of the invention, which may be made by those skilled in the art without departing from the scope and range of equivalents of the invention.

The present invention is a system and method for transmitting and receiving audio, video, or a combination of both types of media as a media file or “media object”, multimedia services, and/or Internet compatible content such as web pages (ex. Hyper Text Markup Language (HTML) compatible pages, or the like (to be known as requested resources) that are delivered through a communications network via a gateway device. As used herein, the term “media object” includes audio, video, textual, multimedia data files, and streaming media files. Multimedia objects comprise any combination of text, image, video, and audio data. Streaming media comprises audio, video, multimedia, textual, and interactive data files that are delivered to a user via the Internet, satellite or other communications network environment and begin to play on the user's computer/device before delivery of the entire file is completed. Media objects may be transmitted over any communications network including via the Internet, satellite (DSS, DVB-S), cable, DSL, T1 lines, wireless network, or other delivery systems capable of delivering media objects. Such defined objects or services originate from sources known a resource providers, as web site, storage sites, streaming media sites, file storage sites, media service provides (television/radio stations) and the like.

Examples of the content of media objects include songs, political speeches, news broadcasts, movie trailers, movies, television show broadcasts, radio broadcasts, financial conference calls, live concerts, web-cam footage, and other special events. Media objects are encoded in various formats including REALAUDIO®, REALVIDEO®, REALMEDIA®, APPLE QUICKTIME®, MICROSOFT WINDOWS® MEDIA FORMAT, QUICKTIME®, MPEG-2 VIDEO COMPRESSION, MPEG-4 VIDEO AND/OR AUDIO COMPRESSION, JOINT VIDEO TEAM COMPRESSION FORMAT (MPEG-4 part 10 AVC, H.264), MPEG-2 LAYER III AUDIO, MP3®. Typically, media objects are designated with extensions (suffixes) indicating compatibility with specific formats. For example, media objects (e.g., audio and video files) ending in one of the extensions, .ram, .rm, .rpm, are compatible with the REALMEDIA® format. Some examples of file extensions and their compatible formats are listed in the Table 1. A more exhaustive list of media types, extensions and compatible formats may be found at http://www.bowers.cc/extensions2.htm.

TABLE 1

| Format | Extension |
|---|---|
| REALMEDIA ® | .ram, .rm, .rpm |
| APPLE QUICKTIME ® | .mov, .qif |
| MICROSOFT WINDOWS ® | .wma, .cmr, .avi |
| MEDIA PLAYER | |
| MACROMEDIA FLASH | .swf, .swl |
| MPEG | .mpg, .mpa, .mp1, .mp2 |
| MPEG-2 LAYER III Audio | .mp3, .m3a, .m3u |

A gateway device is the access point or communications interface between a resource requester such as a user's computer (or local home/business network) and a communications network (outside the user's computer, or local home or business network). Typically, a set top box, DSL modem, cable modem, or other type of communications interface is used to connect a resource requester to a communications network as the Internet to a resource provider. Gateway devices, by design, can support multiple users through a common node. Hence, a family that has a DSL connection that is connected to a DSL modem can access multiple resource providers via the Internet through the supplied gateway (DSL modem).

Many systems that are referred to as networks accommodate multiple of users or devices. Networks either in the home or in the business place (referred to as Local Area Networks, Wide Area Networks, Fiber Networks, and the like) may use different types of communications technologies to enable multiple users to utilize a common gateway device to access resource providers via a communications network. Some commonly used networking technologies are Ethernet, 802.11a, 802.11b, BLUETOOTH™, IEEE 1394, Universal Serial Bus (USB), HAVI, and other types of hard wired and wireless connections are used to network devices. Other types of communications technologies may be used, but the importance of the gateway is that it provides a nexus for multiple users to access a communications network, while providing such access in a simple manner (one point access versus multiple points of access for each resource requester).

The communications between resource requesters on a network, a gateway device, and a communications network are facilitated through the use of a communications protocol. Once commonly used protocol is known as Transmission Control Protocol-Internet Protocol (TCP/IP), see RFC 1780 “INTERNET OFFICIAL PROTOCOL STANDARDS” available at http://www.faqs.org/rfcs/rfc1780.html. This protocol standardizes data into packetized segments consisting of a header and a payload. The packet header contains the information used to manage the communication of data between devices and networks. The payload data is the information that provides the request resource (content part) of the packetized data such as the data containing e-mails, media objects, web content, interactive services and the like.

The resources that are available through the communications network, or on the local home or business network, are accessed by using a uniform resource indicator (URI), which provides the source and destination addressed for the packetized data communicated between resources. URIs are a universal set of names that refer to existing protocols or name spaces that identify resources (e.g., website, streaming media server,), services as resources (e.g., videos on demand, internet radio), devices with resources (e.g., mobile phone, internet enable appliance), and resources as data files (e.g., media files and text documents). A URL is a form of a URI that expresses an address that maps to an access algorithm using network protocols (e.g., TCP/IP or a MPEG transport scheme). When a URL is used, a specific resource, service, device, or data file may be accessed and/or manipulated. An alternative form of a URI known as an Internet protocol number or address (IP) is a series of numbers that refers to a specific resource, service, or data file. IP number, thereby providing two ways to access a desired resource (e.g., a resource is accessed either by using www.whitehouse.gov or the IP address 198.137.240.91).

The preferred embodiment of the invention operates with resources, resource providers, and resource requesters as being accessible through the local network and the communications network via IP address. It should be noted that the invention also would operate with the gateway device as being the only device that communicates with the communications network with an IP address, instead of a resource requester. The system would then make use of a technique called Network Address Tables (NAT) whereby the gateway device would dynamically assign IP addressed to a resource requesting device on a local network that would not be seen to the outside communications network. The uses of NATs allow for a gateway to control the flow of information to and through the communications network to obtain requested resources (via a firewall), while narrowing the possibility of outside security threats.

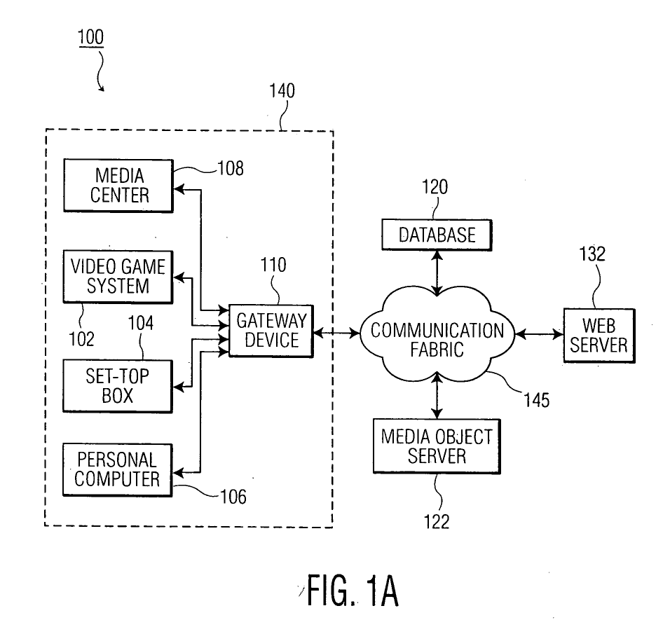

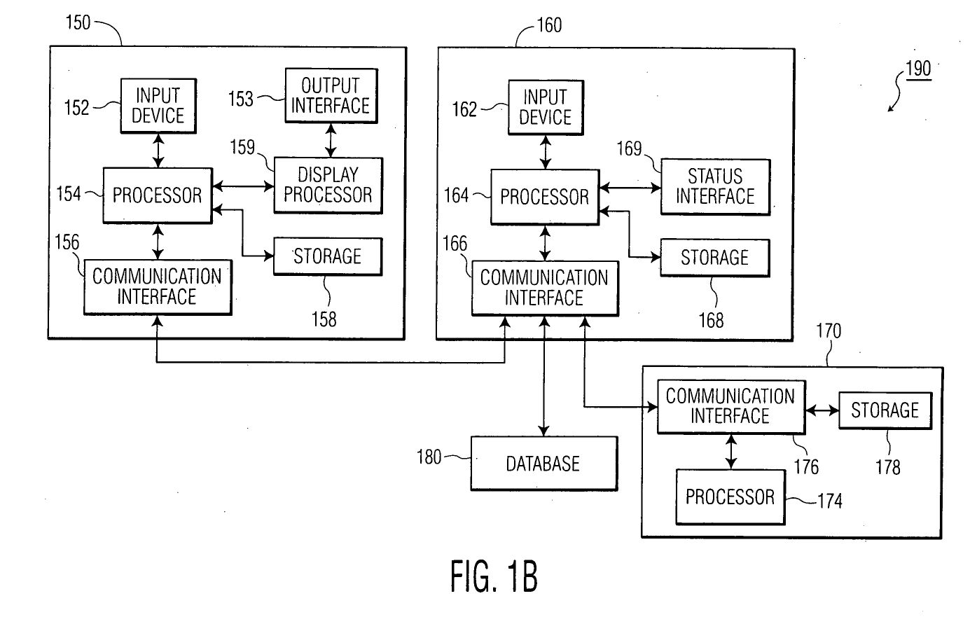

In FIG. 1A, a system shows an architecture of an exemplary embodiment of the present invention. System 100 displays an operational schematic between a resource requester, a resource provider, and a gateway device between the resource requester and resource provider. Local network 140 (as an wired, wireless, or combination thereof based network) demonstrates different types of users or devices that are referred to as a resource requester. Different types of resource requesters include video game system 102, set top box 104, personal computer 106, media center 108, although other types of devices may be used to request resources from a communications network. Preferably, a resource requester makes a request via a command that is capable of being transmitted through a TCP/IP based protocol. The types of information or services requested from a resource requester may vary, for example video game system 102 communicates information for a game service as moves of a chess game, versus personal computer 106 that requests a web page from a resource provider.

Examples of different types of resource providers are media object server 122 and web server 132. Both of these types of resource providers operate and communicate with other devices (accessible through local network 140) via communications fabric 150 (which represents a communications network such as the Internet). Media object server 122 (as a large file server of gigabytes or terabytes of media objects) delivers media objects to a resource requester (for example, the media object server 122 transmits a streaming media based audio broadcast to set top box 104). Web server 132 similarly delivers web pages to a resource requester in response to a Hyper Text Transmission Protocol (HTTP) compliant GET command by using the URI corresponding to a requested web page. Other types of resource request commands may be used to request and receive resources available through a communications network, in accordance with the present principles of the present invention.

Gateway device 110 is the interface that operates between the local network of resource requesters (on local network 140) and the communications network (communications fabric 150) that has the resource providers. Gateway device 110, typically a cable modem, DSL modem, PSTN enabled modem, network hub, or other type of communications network compatible interface, acts as a gatekeeper between local and remote (the communications network) resources. Advantageously, gateway device 110 monitors communications traffic between resource requesters and providers transparently, without having to run special software at either end of the communication. That is, gateway device 110 provides services such as network security or content filtering, where gateway device 110 determines if a resource requester has access to a requested resource, without interaction either through the resource requesters or providers. Additionally, gateway device 110 accommodates multiple connections to resources available through a communications network, for example video game system 102 and media center 108 are connected via an Ethernet connection to gateway device 110, as for each requester to simultaneously access different resources.

Gateway device 110 interoperates with database 120 for providing services to resource requesters depending on requests made for resources available through a communications network. Database 120 is SQL or MICROSOFT ACCESS TM compliant database that has references (such as URL links, pre-cached advertisement, animations, media objects, programming scripts, and the like) as ancillary information that are related to resource requests. For example, a request to a URI to a web travel website, would result in database 120 returning information related to the United States State Department Travel Advisory Service. Gateway device 110 may also have ancillary information pre-cached at its location, depending upon the availability of memory. Additionally, gateway device 110 may be updated by database 120 as an system upgrade or to pre-cache ancillary information related to frequently requested resources, although gateway device 110 may operate with other available databases through communications fabric 150.

FIG. 1B is a diagram of the discrete components forming the communications architecture of an exemplary embodiment of the present invention. Personal computer 150 represents a device that is used to request a resource available through a communications network. Personal computer 150 has a processor 154 that controls a majority of system operations, including programs used on the personal computer to access and generate requested resources. Processor 154 is coupled to the input and output interfaces used by a user to operate personal computer 150. For example, a sample input device 152 is a keyboard, mouse, pointer, trackball, or the like. The output interface is the system of display processor 159 that generates a signal that is capable of being displayed through output interface 153 (on a monitor or television screen). Processor 154 is also coupled to storage 158 that may be in the form of: Random Access Memory, Read Only Memory, memory chips, hard drives, floppy disc drives, memory sticks, compact discs, video digital discs, and a combination thereof. Storage device 158 may also store computer programs, user related information, and multimedia tools to enable the operation of requested resources.

Communications interface 156 is a component of personal computer 150 that is controlled by processor 154 enabling communication of the device. A networking port or a networking card (Ethernet compatible, wireless interface, or the like) is the preferred form of communications interface 156. Alternatively, a dial up modem, or other type of networking enabled port can be used for communications interface 156. Communications interface 156 also enables personal computer 150 to be addressed by an IP address, a Media Access Control address, a dynamically generated IP address, or other type of addressing technique that identifies a device by a series of numbers, alphanumeric characters, or other identification means.

Gateway device 160 represents a preferred embodiment of a gateway device. Processor 164, input device 162, communications interface 166, and storage 168, are similar to their personal computer 150 counterparts. Status interface 166 indicates the current operating modes or statuses of gateway device 160. Status interface 169 has indicators that may be visually displayed (for example, LED lights, LCD display, and the like) and/or an audibly sounded (loudspeaker, voice synthesis, alarm, and the like). Storage 168, aside for storing system operational information, may contain ancillary information related to a requested resource, update information to upgrade gateway device 160, resource requester profile information, and additional operating instructions necessary for the operation of the current invention. Communications interface 166 acts provides the hub interface for devices locally networked (as local network 140) to transmit and receive data to each other and from an a communications network. Additionally, communications interface 166 provides the interface for gateway device 160 to communicate with resource providers (as web server 170) through a communications network (as communications fabric 140, from FIG. 1A) via a broadband connection (as a T1 line, DSL, cable modem, etc.). Preferably, the communications between gateway device 160 and resource providers are TCP/IP compliant, although other networking communication protocols may be used (Real Time Protocol, etc.). Gateway device 160 also communicates with database 180 to receive auxiliary information not currently stored in gateway device 160.

Web server 170 is an example of a resource provider that supplies a requested resource to personal computer 150 (personal computer). Processor 174 controls the operation of web server 170, including processing of requests and delivery of generated and stored data to form web-based pages. The delivery of data from web server 170 includes forms of data as HTML, Extendible Markup Language (XML), JAVA™ commands, or other types of script or commands that represent data that may be visually or audibly generated on an output device (for example, a display device or loudspeaker). Communications interface 176 communicates with gateway device 160, and storage 178 stores that data used to generate and distribute a requested video source. Storage 178 may be read only or a re-writable memory device.

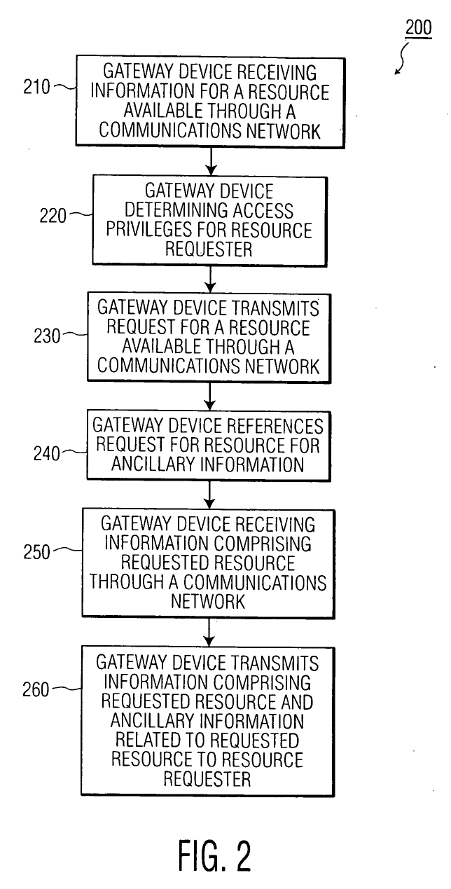

FIG. 2 a flowchart of the operation of present invention for delivering ancillary information related to a requested resource via a gateway device. Method 200 displays an exemplary embodiment of the present invention. This embodiment of the present invention operates with the reference numerals in view of FIG. 1B. Personal computer 150, in this embodiment requests a web page generated by web server 170, although other types of resources may be requested, as explained earlier in this specification. The resource requester uses an HTML compliant browser (for example, MICROSOFT INTERNET EXPLORER™, NETSCAPE™, and the like) to request a web page. Web server 170 responds with data representing the requested resource, a web page, which is then generated on output interface 153 once computer 153 receives the requested resource. Gateway 160 resolves and monitors the communications between personal computer 150 (resource requester) and web server 170 (resource provider).

Step 210 has gateway device 160 receiving an information request from a resource requester for a resource available through a communications network. In this exemplary embodiment of the invention, the resource requester (personal computer 150) requests a resource located at the URI http://www.rca.com, via a web browser. The command for the resource located at the URI is called a “GET HTTP HEADER” command, whereby a GET HTTP://WWW.RCA.COM command is issued via the browser to the gateway device 160. Within the GET command, the issuer of such a command can also reference the version of HTTP being used, the browser issuing the command, and a cookie or personal identifier value that identifies the resource requester. These attributes are represented in the following command syntax “GET (URL) HTTP\1.0”+(Char13)+Char(10)+“User-Agent” browser type“+Char(13)+Char(10)+”Cookie:C=resource requester identifer). Other forms of HTTP syntax commands or other types of requests for resources (depending on the command format of a request) may be used for requesting resources.

In the present example, gateway device 160 receives the HTTP GET command from personal computer 150. From the syntax of the command, the gateway device 160 determines the device that sent the request, the browser type being used, and the version of HTTP that the requesting device uses. Gateway device 160 also makes use of the cookie or personal id information embedded in the HTTP command to reference a profile of the user making the request for a resource. The cookie or personal identifier preferably refers to an user identifier that is stored locally in gateway device 160. Gateway device 160 may also use the cookie to identify a user by referencing the identifying information against a index of user profiles stored in database 180. Information that would be available from database 180 includes a user e-mail address, user biographical information, most frequently requested resources, marketing data, resource access privileges and other types of information corresponding to the identification of a user. Alternatively, a resource requester (or user) may be identified by the IP address, dynamically assigned IP address, or the MAC address of the device requesting a user resource. The IP address then would be referenced against stored information in gateway device 160 and/or database 180.

As part of the referencing process, gateway device 160 determines if a resource requester has permission to access the location of a resource, or permission to obtain the resource itself, step 220. Based on requester identification information, gateway device 160 references the user identifier against an index of user permissions. Such permissions can be pre-assigned within the scheme of a content filtering program, a parent, a company, or other type of party that would be concerned with the unwarranted access of resources. This information may be entered via a graphical user interface, a table, or other means that accommodate information being entered in a tabular format. An example of an index with access permissions is represented in the TABLE 2 below.

TABLE 2

| USER | | |
|---|---|---|
| IDENTIFIER | USER E-MAIL | WEBSITE ACCESS |
| 8388448838 | MIX@RCA.COM | WWW.RCA.COM-2 |
| 8388448838 | MIX@RCA.COM | WWW.THOMSON.COM-2 |
| 8388448838 | MIX@RCA.COM | WWW.BOWLING.ORG-0 |
| 1828388482 | TINTIN@RCA.COM | WWW..CONTIS.COM-1 |

Table 2 lists a user identifier number with a corresponding e-mail address corresponding to a user requesting a resource, the identifier from a cookie or personal identifier value. In the present example, number “8388448838” corresponds to a user at the e-mail address at MIX@RCA.COM. The table also references the degree of access that the user “MIX” has, and what resource the user may access, such as the resources available from the URIs of WWW.RCA.COM, WWW.THOMSON.COM, and WWW.BOWLING.COM. In addition, there is a number listed after each resource that defines the user access privileges for a specific resource. “2” represents complete access to a resource, “1” represents that a user has access to text on the site, but gateway device 160 will not let either programming objects through (such as JAVASCRIPT™ objects) or media objects, and “0” represents a resource from which the requester is completely restricted from. Gateway device 160 also notifies the resource requester with a restrictive message if access to a resource is limited.

If gateway device 160 determines that a resource requester has access to a resource, the request is transmitted by gateway device 160 through a communications network to the resource provider (web server 170), step 230. The request command from gateway device 160 is issued as the same HTTP GET command, as issued from the resource requester, and is transmitted over a TCP/IP compliant protocol as packetized data. Gateway device 160 resolves the URI or URL of the resource via a source as a domain name server (WHOIS provided by INTERNIC compliant server) that lists resources by IP address, although other identifying methods may be used, as appreciated by one skilled in the art. Web server 170 receives the request command (through a communications fabric 145, see FIG. 1A) where the request is processed. Web server 170 then returns packetized data representing the requested resource back to the resource requester through gateway device 160. Alternatively, gateway device 160 may reformat the resource get command if there are problems of compatibility between resource requester and resource provider. For example, based on the requested address of a resource, gateway device 160 interacts with a resource provider in HTTP v. 1.0, while the request for the resource was a command comporting to HTTP v. 2.0. The command translations for reformatting commands is done via a translation table either accessed at gateway device 160 or database 180.

In step 240, gateway device 160 references if ancillary information related to the request for resources is available. Ancillary information is data graphical, audio, and/or textual data that is used to supplement a resource. Examples of ancillary information include additional locations of resources, web site links, audio files, video files, news, sports, advertisements, streaming media, electronic programming guide information, commerce information, auction information, and the like. In the preferred embodiment of the invention, ancillary information is stored in a tabular format at gateway device 160 and/or accessible through database 180. Such information may be updated upon the needs of the system, or as resources becomes available. An example of a request for a resource, and corresponding ancillary information is shown in Table 3 below, where the URI (or locator) of a resource is matched to corresponding ancillary information. Gateway device 160 then performs its own request for ancillary information using the reference to where ancillary information is located. For example gateway device 160 issues an HTTP GET command to a website where ancillary information is located.

TABLE 3

| UNIVERSAL | ANCILLARY | OBJECT |
|---|---|---|
| RESOURCE LOCATOR | INFORMATION | CLASS |
| WWW.RCA.COM/ | WWW.SALESCOM.COM/ | Web Site |
| | TELEVISION | |
| WWW.RCA.COM/ | MANUALS.HTML | HTML File |
| TECH.HTML | | |
| MUSIC.SERVER.COM/ | WWW.SINGINGFISH.COM/ | Searchable |
| LOLA.MP3 | ?*CLAPTON+ERIC | Query to |
| | | Search Engine |
| WWW.RCA.COM/ | WWW.SUPERSTORE.COM/ | Advertisement |
| PRODUCTS | RCAPROMOTE.HTM | |

Gateway device 160 uses information, such as the items presented in Table 3 for delivering ancillary information related to a requested resource. If a resource requester wants a resource located at the URI of “WWW.RCA.COM”, gateway device 160 refers this URI to information in Table 3 to reference ancillary information located at the URI of WVWW.SALESCOM.COM/TELEVISION, which refers to an Internet site allowing a requester to compare prices of different appliances. A request for WWW.RCA.COM brings up an advertisement script of a superstore located at WWW.SUPERSTORE.COM/RCAPROMOTE.HTM, although other advertisements (or HTML scripts) may be presented. If a resource requester wanted a media object located at “MUSIC.SERVER.COM/LOLA.MP3”, gateway device 160 would refer to a search engine located at WWW.SINGINGFISH.COM/?*CLAPTON+ERIC, using indexing information as presented in Table 3.

Optionally, gateway device 160 parses a request for resource to determine if additional types of service are available, depending on the resource being requested. For example in the request for the LOLA.MP3, gateway device would find the “.MP3” extension as representing a request for a music file, see Table 1 for other types of identifiable extensions. Gateway device 160 by recognizing the .MP3 extension, scans the URI for information before the extension. In the present example, gateway device 160 finds and submits the term LOLA to a music based search engine to determine if there was any information related to this term. If the search yields a positive result, gateway device 160 receives the search result and formats the ancillary information at the proper time. An index of identifiable objects or resources may be stored in database 180 or gateway device 160, with a list of corresponding search engines or sources of additional ancillary information. Gateway device 160 may also parse the metadata associated with a returned resource either by reading the Synchronized Multimedia Integration Language (SMIL) header associated with the resource, parsing a programming script operating a resource (JAVASCRIPT™, for example) or by reading metadata contained within the resource itself. Gateway device 160 searches for key commands or terms, in the same way as when parsing a URI of a requested resource, when finding metadata. Optionally, gateway device 160 ranks received ancillary information, first the information received directly related to a resource locator, then metadata associated with a requested resource is used when transmitting ancillary information related to a requested resource to a requester.

Gateway device 160 in step 250 receives information comprising the requested resource through a communications network. In this example, gateway device 160 receives a requested resource from web server 170, (the resource is for a web page), consisting of an HTML based script which may have additional audio, video, or programming objects transmitted in the script. The information transmitted to gateway device 160 depends on the resource being requested; a requested resource of an audio file would be audio data while a requested text file would be text data. Within this step, gateway device 160 receives ancillary information related to a requested resource if it is available.

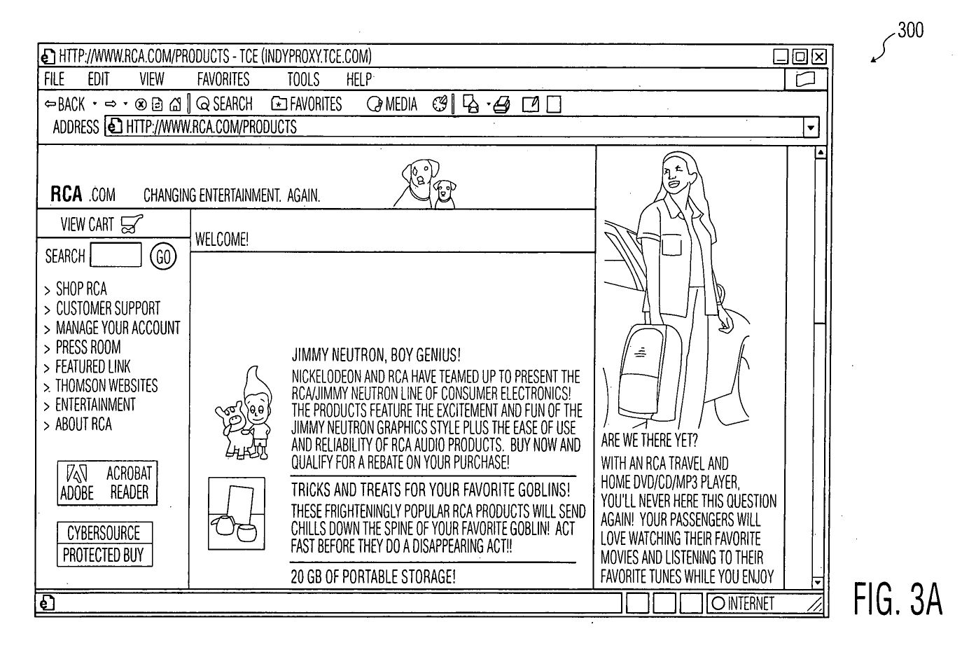

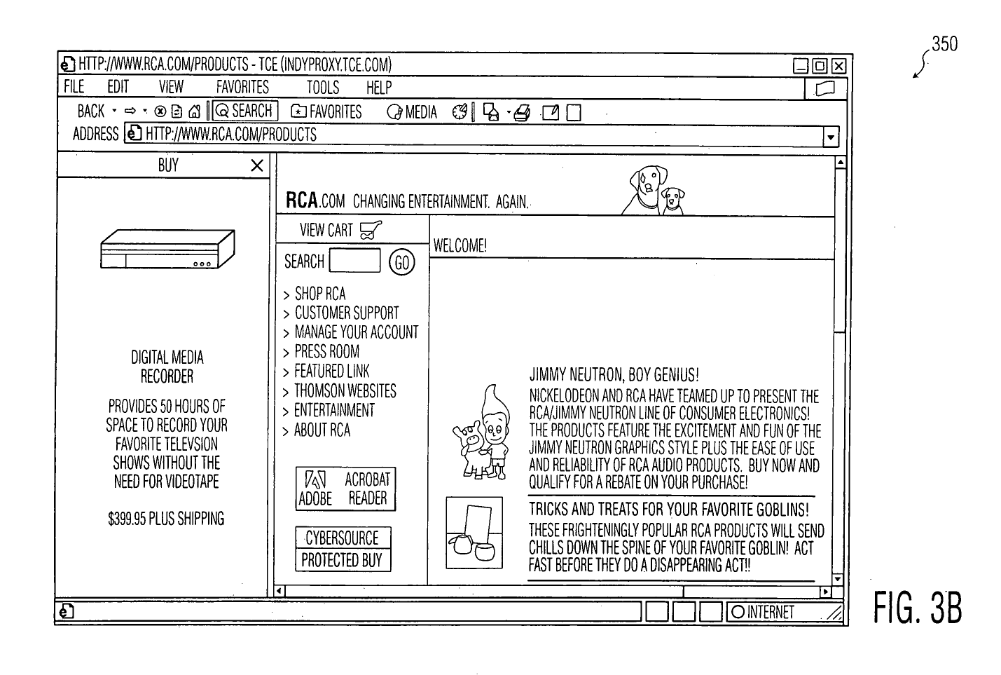

Step 260 has the gateway device transmitting information comprising the requested resource and ancillary information related to the requested resource to the resource requester. In this example, gateway device 160 transmits a requested resource (from web server 170) back to personal computer 150 through a local network connection. This information is presented on a web browser at personal computer in the form of a web page. A sample display of this result is shown in FIG. 3A displays the HTML script of a web page 300 located at the URI WWW.RCA.COM/PRODUCTS, listed in address bar 310, designating a requested resource. Generated resource data 320 shows the generated HTML script of the requested resource.

With step 260, gateway device 160 also presents the ancillary information related to a requested resource. In the present example, gateway device 160 determined that ancillary information was located at WWW.SUPERSTORE.COM/RCAPROMOTE.HTM, as to compare the URI WWW.RCA.COM/PRODUCTS to the index of data listed in Table 3. Gateway device 160 generates the display of ancillary information by opening an additional frame in the browser of personal computer 150. By identifying the browser used to request a resource, as explained above, gateway device 160 opens an additional window by using an open command as “window.open”, as used for an INTERNET EXPLORER™ compatible browser. Gateway device 160 may use other visual or audio generation techniques to display or audibly portray ancillary information related to a resource request.

The information representing the ancillary information located at WWW.SUPERSTORE.COM/RCAPROMOTE.HTM is displayed in FIG. 3B of web page 350. The browser displays the web page information of the URI of WWW.RCA.COM/PRODUCTS (listed in address bar 360) as generated resource data 370, which includes the received ancillary information (in the form of an advertisement) in generated ancillary information data 380. In this example, a purchase button 385 is displayed. When activated, purchase button 385 allows an identified user to purchase the displayed object in generated resource data 370, in this example a digital media recorder. Optionally, other actions may be performed depending upon the ancillary information and the requested resource, for example, a requested resource of a movie would display ancillary data of other available movies or movies available for purchase, instead of purchase button 385

Within the current example, when a resource requester activates purchase button 385, gateway device 160 may facilitate the transaction by transmitting the personal information of the requester to a purchasing clearinghouse. Based on the facilitation of the transaction, the operator of gateway device 160, or a provider of a request resource would receive a commission based on the purchase. Alternatively, other types of economic transactions may be made available if a resource requester enables a script or button generated from ancillary information related to a requested resource.

Within the operation of the invention, gateway device 160 may replace requested resources, or parts of requested resources with other objects. For example, the gateway device 160 may replace an ad based in an HTML document, with an alternative ad based upon referenced ancillary information. The operation of this function is within the principles of the present invention, as explained above, by using the information located in at gateway device 160 or database 180, and replacing part of a requested resource with ancillary information. For example, a GIF of an ad referring to bottled water (in a HTML script of a requested web page) would be replaced with a GIF referring to alcohol. This may be done based upon the preferences of a resource requester, as determined in accordance with a user profile and/or prior requests of resources. The invention accommodates other types of requested resource replacements, based on the requested resource and the ancillary information available.

1. A method for supplying ancillary information related to a request for a resource through a communications network comprising the steps of:
receiving information comprising a request for said resource corresponding to a media object composed of at least one of video and audio information which is available through a communications from a resource requester;
referencing said request to determine availability of ancillary information related for request by analyzing said request, said referencing step is performed by parsing non-HTML metadata within said requested media object;
transmitting information representing said requested resource available from said communications network and said ancillary information to a requester of said resource request.

2. The method of claim 1, wherein said method comprises an additional step of determining access privileges for said resource requester.

3. The method of claim 1, wherein said method comprises an additional step of receiving information comprising said resource from a resource provider.

4. The method of claim 1, wherein said referencing step identifies said ancillary information by identifying a Uniform Resource Identifier component of said request.

5. The method of claim 4, wherein said identified Uniform Resource Identifier is compared in a database for said ancillary information.

6. The method of claim 1, wherein said method is performed by a gateway device facilitating packetized data communications from said resource requester to said resource provider.

7. The method of claim 1, wherein during said referencing step, said ancillary information is received from a search engine upon identifying metadata within said requested resource.

8. An apparatus of a gateway device for supplying ancillary information related to a request for a resource through a communications network comprising:
a means for receiving information for said gateway device in a local network comprising a request for said resource corresponding to a media object composed of at least one of video and audio information which is from a resource provider;
a means for referencing said request to determine availability of ancillary information related for request by analyzing said request, said referencing is performed by parsing non-HTML metadata within said requested media object;
a means for transmitting information representing said requested resource available from said communications network and said ancillary information to a requester of said resource request.

9. The apparatus of claim 8, wherein said apparatus comprises an additional means for determining access privileges for said resource requester.

10. The apparatus of claim 8 wherein said apparatus comprises an additional means for receiving information comprising said resource from said resource provider.

11. The apparatus of claim 8, wherein said means for referencing identifies said ancillary information by identifying a Uniform Resource Identifier component of said request.

12. The apparatus of claim 11, wherein said identified Uniform Resource Identifier is compared in a database for a reference corresponding to a resource for said ancillary information related to said requested resource.

13. The apparatus of claim 8, wherein said gateway device facilitates communications data from said resource requester to said resource provider.

14. The apparatus of claim 8, wherein said means for referencing receives said ancillary information from a search engine upon identifying metadata related to said requested resource.

15. The apparatus of claim 8, wherein said ancillary information represents data comprising an advertisement.

16. An apparatus for providing an advertisement related to a requested resource available through a communications network, wherein said apparatus as a gateway device facilitates communications between a resource requester and a resource provider, said apparatus comprising:
a communications interface that receives a request for a resource available through said communications network, where said request is a uniform resource locator;
a processor that parses said request for information within said uniform resource locator as to identify an attribute from said parsed information; and
a storage device that comprises information for comparing said identified attributes to data representing advertisements related to said resource request, where said attribute from said uniform resource locator is the only information used for said comparison wherein
said processor controls retrieval of said advertisements; and
said a communications interface transmits data comprising said advertisements and said requested resource.

17. The apparatus of claim 16, wherein said communications interface transmits said advertisement to said resource requester.

18. The apparatus of claim 16, wherein said apparatus resolves an Internet Protocol address of said resource requestor by using Network Allocation Tables.
